(19) United States
(12) Patent Application Publication
(10) Pub. No.: US 2008/0053007 A1
(43) Pub. Date: Mar. 6, 2008

(54) CONNECTOR FOR INSULATING GLAZING UNITS WITH MULTIPLE BARRIERS FOR MOISTURE VAPOR AND GAS

(76) Inventor: Raymond G. GALLAGHER, Pittsburgh, PA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/843,708

(22) Filed: Aug. 23, 2007

Related U.S. Application Data
(60) Provisional application No. 60/824,035, filed on Aug. 30, 2006.

(51) Int. Cl. E06B 7/10

(52) U.S. Cl. 52/171.3

(57) ABSTRACT

The subject application is directed to a connector with multiple barriers for moisture vapor and gas that provides a hermetically sealed joint in a spacer bar. The multiple barrier members include yielding feathers, yielding ribs, yielding feathered ribs, or interlaced yielding ribs and collars. The barrier members engage with the seal liner of respective portions of an associated spacer bar in corresponding engaging areas. A predetermined relationship between the fusing temperature of the barrier members and the fusing temperature of the seal liner establishes hermetic bonding resulting from a heating exposure of the corresponding engaging areas.

### CROSS-REFERENCE TO RELATED APPLICATION

This application claims the benefit of priority of U.S. Provisional Patent Application Ser. No. 60/824,035, filed Aug. 30, 2006.

### BACKGROUND

The subject application is directed generally to the field of insulating glazing units. More particularly, the subject application is directed to reducing moisture vapor transmission and gas loss at joints in spacer bars used in insulating glazing units. In particular, the subject application is directed to a connector with multiple barriers for moisture vapor and gas that provides a hermetically sealed joint in a spacer bar.

Conventional insulating glazing units typically use a tubular spacer bar to separate panes of glazing forming the insulating glazing unit. The space between panes of insulating glass is typically filled with air or a colorless and odorless gas, such as argon. The addition of argon greatly increases the thermal performance of a window by minimizing heat transfer. The interior of the spacer bar frame is typically provided with a seal liner, which is composed of a thermoplastic material with good adhesion to the spacer frame and a low moisture vapor transmission. The seal liner serves to prevent moisture vapor penetration through the spacer frame. In common practice, when forming a rectangular or multi angular glazing unit, the spacer bar work piece is cut into specific lengths and respective portions are then connected using some sort of connector device to form the corners of the spacer arrangement, or frame, of the glazing unit. The design of the connector device and its material varies, including stamped metal, cast alloy piece, injected molded plastic, and the like. The device used to connect the spacer bar portions to form the corners of the frame is referred to as a corner connector or corner key. In addition, miscellaneous portions of spacer bar work piece are generally used to form a length of the frame, so as to conserve spacer material, connected via some linear connecting device. This leads to at least four points at which leaks are capable of developing, as well as gaps in the spacer bar such that continuous insulation is impossible, irrespective of the type of connector device used. Alternatively, bending of a single piece of spacer material so as to minimize connector device usage has been implemented via a linear connector or linear key arrangement. However, even limiting the connection to a single joint does not entirely minimize moisture vapor transmission and gas loss, the latter cutting short longevity of an associated spacer bar, and thereby longevity of the entire glazing unit. To minimize moisture vapor penetration and gas loss through the connector joint, the joint is known to be provided with a hot melt sealant, such as a butyl sealant. However, using a hot melt sealant is a slow messy process with only limited effectiveness.

### SUMMARY OF INVENTION

In accordance with one embodiment of the subject application, there is provided a connector for joining respective portions of an associated spacer bar of an insulating glazing unit that provides a hermetically sealed joint.

Further, in accordance with one embodiment of the subject application, there is provided a connector that extends longevity of an associated spacer bar of an insulating glazing unit by reducing moisture vapor transmission and gas loss at a spacer bar joint.

Still further, in accordance with one embodiment of the subject application, there is provided a connector with multiple barriers for moisture vapor and gas, for joining respective portions of an associated spacer bar of an insulating glazing unit that provides a hermetically sealed joint.

In accordance with one embodiment of the subject application, there is provided a connector for an associated spacer bar for an associated insulating glazing unit. The associated spacer bar includes an interior surface covered with a seal liner, and an inner space. The connector comprises a connector body comprising two legs. Each of the two legs of the connector body is adapted for insertion into an inner space of a respective portion of an associated spacer bar and engaging with the respective portion of an associated spacer bar in corresponding engaging areas. The two legs of the connector body are further adapted for forming multiple barriers for moisture vapor and gas, and comprise multiple barrier members. The multiple barrier members are adapted for engaging with the seal liner of respective portions of an associated spacer bar in corresponding engaging areas and establishing corresponding hermetic bonding in at least the corresponding engaging areas.

Still other objects, advantages and aspects of the subject application will become readily apparent to those skilled in this art from the following description wherein there is shown and described a preferred embodiment of the subject application, simply by way of illustration of the best modes suited to carry out the subject application. As it will be realized by those skilled in the art, the subject application is capable of other different embodiments and its several details are capable of modifications in various obvious aspects all without departing from the scope of the subject application. Accordingly, the drawings and description will be regarded as illustrative in nature and not as restrictive.

### BRIEF DESCRIPTION OF THE DRAWINGS

The accompanying drawings incorporated in and forming a part of the specification, illustrate several aspects of the subject application, and together with the description serve to explain the principles of the subject application. In the drawings:

FIG. 1 is a schematic view of a linear connector for an associated spacer bar of an insulating glazing unit in accordance with one embodiment of the subject application;

FIG. 2 is a schematic view of a linear connector for an associated spacer bar of an insulating glazing unit in accordance with another embodiment of the subject application;

FIG. 3 is a schematic view of a linear connector for an associated spacer bar of an insulating glazing unit in accordance with another embodiment of the subject application;

FIG. 4 is a schematic view of a linear connector for an associated spacer bar of an insulating glazing unit in accordance with another embodiment of the subject application; and

FIG. 5 is a schematic view of a corner connector for an associated spacer bar of an insulating glazing unit in accordance with one embodiment of the subject application.

### DETAILED DESCRIPTION OF THE PREFERRED EMBODIMENT

The subject application is directed to the field of insulating glazing units. More particularly, the subject application is directed to reducing moisture vapor transmission and gas loss at joints in spacer bars used in insulating glazing units. In particular, the subject application is directed to a connector with multiple barriers for moisture vapor and gas that provides hermetically sealed joints in a spacer bar.

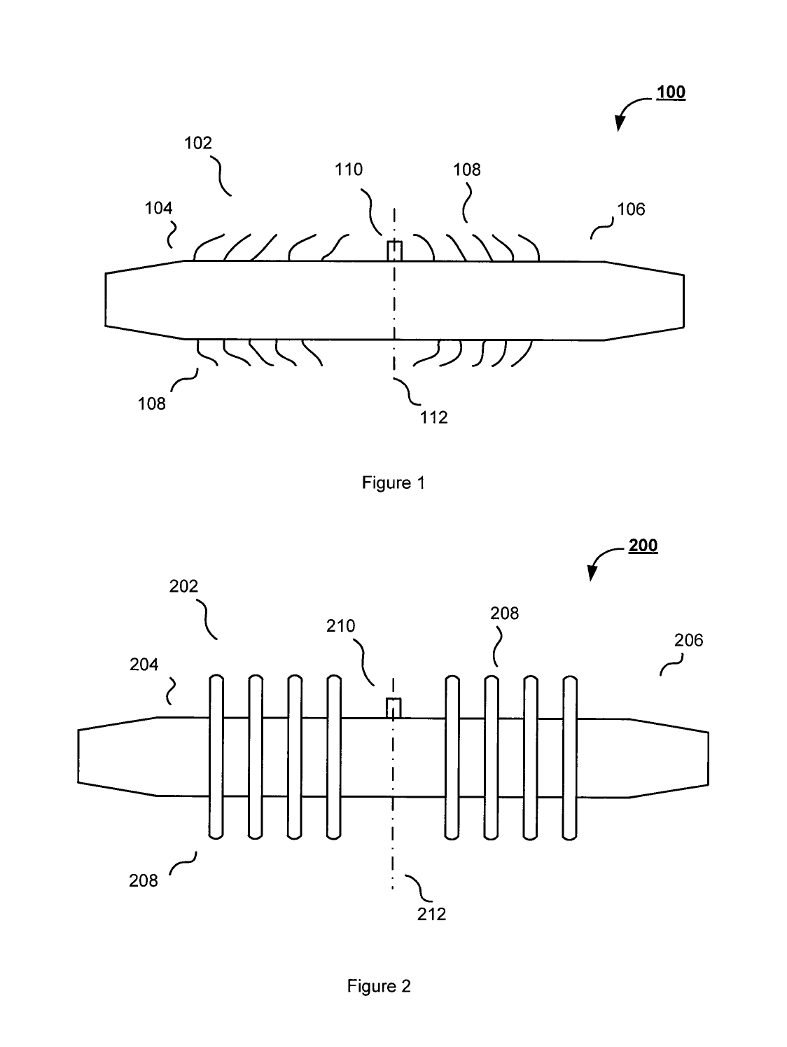

Turning now to FIG. 1, there is shown a schematic view of a linear connector 100 for an associated spacer bar of an insulating glazing unit (not shown in the drawing), in accordance with one embodiment of the subject application. As shown in FIG. 1, the linear connector 100 comprises a connector body 102 including two legs 104, 106. The connector body 102 is capable of being made, for example and without limitation, of metal such as aluminum, stainless steel, or the like, as known in the art. Each of the two legs 104, 106 of the connector body 102 is adapted for insertion into an inner space of a respective portion of an associated spacer bar and engaging with the respective portion of an associated spacer bar in corresponding engaging areas (not shown in the drawing).

The two legs of the connector body 102 are further adapted for forming multiple barriers for moisture vapor and gas, and comprise multiple barrier members. With respect to the embodiment of FIG. 1, the multiple barrier members include multiple yielding feathers 108 that cover at least a part of an exterior surface of a corresponding connector leg 104, 106 and are fixedly attached to the corresponding connector leg 104, 106. As will be recognized by those skilled in the art, the yielding feathers 108 are capable of being attached to the corresponding connector leg 104, 106 by any suitable technique known in the art, such as, for example and without limitation, by welding, adhesives, or the like. The yielding feathers 108 are made of a material with a fusing temperature higher than a fusing temperature of a material of the seal liner of an associated spacer bar, such as a suitable thin plastic material. Examples of suitable plastic materials are nylon, high temperature polypropylene, and the like, as known in the art. As further known in the art, the seal liner of an associated spacer bar is typically an adhesive sealant with low thermal conductivity that is capable of exhibiting elastic properties. In the embodiment illustrated in FIG. 1, the connector body 102 further comprises a rigid stud 110 positioned generally adjacent a center line 112 of the connector body 102. As will be understood by a skilled artisan, the rigid stud 110 allows for required positioning of the connector body 102 with respect to an associated spacer bar.

The barrier members, which in the embodiment of FIG. 1 comprise yielding feathers 108, engage with the seal liner of respective portions of an associated spacer bar in corresponding engaging areas, establishing thereby corresponding hermetic bonding resulting from a heating exposure of at least the corresponding engaging areas. In this embodiment, a heating temperature associated with the heating exposure, is lower than the fusing temperature of the material of the yielding feathers 108, and higher than the fusing temperature of the material of the seal liner of an associated spacer bar. As will be recognized by those skilled in the art, the hermetic bonding in this embodiment is established by fusing the material of the seal liner of an associated spacer bar in the corresponding engaging areas. A skilled artisan will understand that the fused material of the seal liner envelopes and adheres the yielding feathers 108 in corresponding engaging areas. As will be further appreciated by those skilled in the art, heating exposure of the at least the corresponding engaging areas of respective portions of an associated spacer bar is provided by at least one of friction welding, ultrasonic welding, radio-frequency welding, microwaves welding, radiation heating, air heating, or direct heating.

Referring now to FIG. 2, there is shown a schematic view of a linear connector 200 for an associated spacer bar of an insulating glazing unit (not shown in the drawing), in accordance with another embodiment of the subject application. As shown in FIG. 2, the linear connector 200 comprises a connector body 202 including two legs 204, 206. The connector body 202 is capable of being made of a material analogous to the material of the connector body 102, depicted in FIG. 1. Each of the two legs 204, 206 of the connector body 202 is adapted for insertion into an inner space of a respective portion of an associated spacer bar and engaging with the respective portion of an associated spacer bar in corresponding engaging areas (not shown in the drawing).

The two legs of the connector body 202 are further adapted for forming multiple barriers for moisture vapor and gas, and comprise multiple barrier members. With respect to the embodiment of FIG. 2, the multiple barrier members include multiple yielding ribs 208 covering at least a part of an exterior surface of a corresponding connector leg 204, 206 and fixedly attached to the corresponding connector leg 204, 206. As will be recognized by those skilled in the art, the yielding ribs 208 are capable of being attached to the corresponding connector leg 204, 206 by any suitable technique known in the art, such as, for example and without limitation, by welding, adhesives, or the like. The yielding ribs 208 are made of a material with a fusing temperature higher than a fusing temperature of a material of the seal liner of an associated spacer bar, such as a suitable plastic material. Examples of suitable plastic materials are nylon, high temperature polypropylene, and the like, as known in the art. The seal liner of a spacer bar associated with the connector 200 is capable of being analogous to that of an associated spacer bar with respect to the connector 100 depicted in FIG. 1, and is typically an adhesive sealant that is capable of exhibiting elastic properties.

In the embodiment illustrated in FIG. 2, the connector body 202 further comprises a rigid stud 210 positioned generally adjacent a center line 212 of the connector body 202. As will be understood by a skilled artisan, the rigid stud 210 allows for required positioning of the connector body 202 with respect to an associated spacer bar.

The barrier members, comprising in the embodiment of FIG. 2 yielding ribs 208, engage with the seal liner of respective portions of an associated spacer bar in corresponding engaging areas, establishing thereby corresponding hermetic bonding resulting from a heating exposure of at least the corresponding engaging areas. In this embodiment, a heating temperature associated with the heating exposure, is lower than the fusing temperature of the material of the yielding ribs 208, and higher than the fusing temperature of the material of the seal liner of an associated spacer bar. As will be recognized by those skilled in the art, the hermetic bonding in this embodiment is established by fusing the material of the seal liner of an associated spacer bar in the corresponding engaging areas. A skilled artisan will understand that the fused material of the seal liner envelopes and adheres the yielding ribs 208 in corresponding engaging areas. As will be appreciated by those skilled in the art, heating exposure of at least the corresponding engaging areas of respective portions of an associated spacer bar is provided by at least one of friction welding, ultrasonic welding, radio-frequency welding, microwaves welding, radiation heating, air heating, or direct heating.

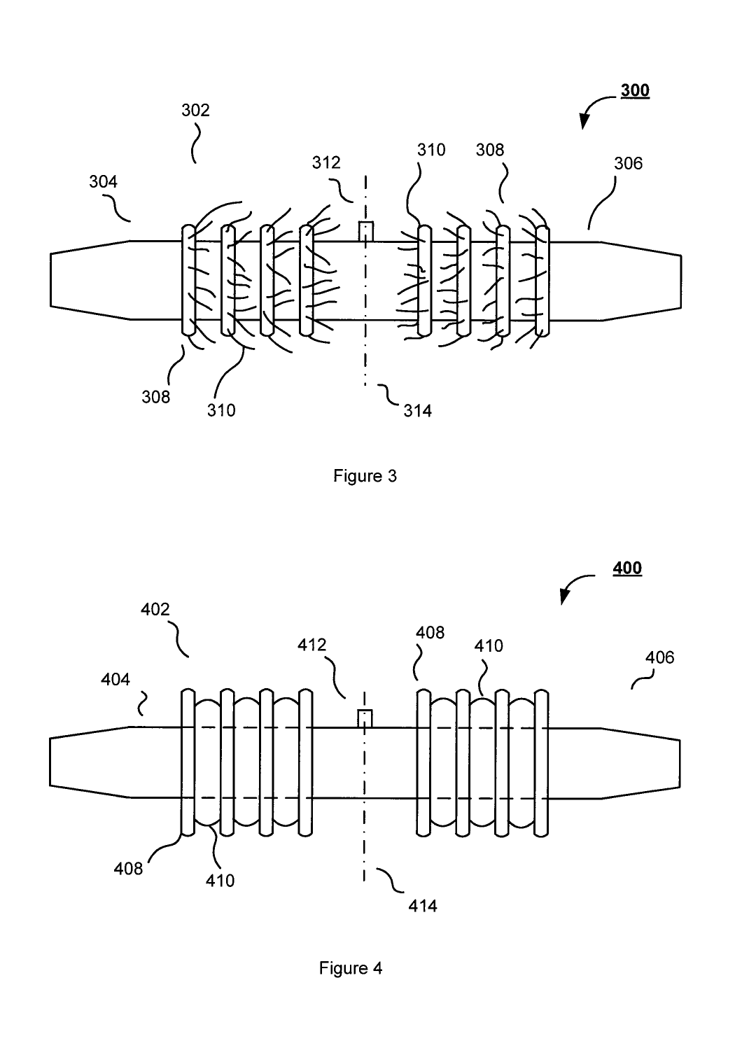

Turning now to FIG. 3, there is shown a schematic view of a linear connector 300 for an associated spacer bar of an insulating glazing unit (not shown in the drawing), in accordance with another embodiment of the subject application. As shown in FIG. 3, the linear connector 300 comprises a connector body 302 including legs 304, 306. A skilled artisan will understand that the connector body 302 is capable of being made of a material analogous to the material of the connector body 102, depicted in FIG. 1. Each of the two legs 304, 306 of the connector body 302 is adapted for insertion into an inner space of a respective portion of an associated spacer bar and engaging with the respective portion of an associated spacer bar in corresponding engaging areas (not shown in the drawing).

The two legs of the connector body 302 are further adapted for forming multiple barriers for moisture vapor and gas, and comprise multiple barrier members. With respect to the embodiment of FIG. 3, the multiple barrier members include multiple yielding ribs 308 covering at least a part of an exterior surface of a corresponding connector leg 304, 306 and fixedly attached to the corresponding connector leg 304, 306. As will be recognized by those skilled in the art, the yielding ribs 308 are capable of being attached to the corresponding connector leg 304, 306 by any suitable technique known in the art, such as, for example and without limitation, by welding, adhesives, or the like. The yielding ribs 308 are made of a material with a fusing temperature higher than a fusing temperature of a material of the seal liner of an associated spacer bar. As shown in FIG. 3, the multiple barrier members further include multiple yielding feathers 310 attached the yielding ribs 308 and covering at least a part of an exterior surface of a corresponding yielding rib 308. Those skilled in the art will appreciate that the yielding feathers 310 are capable of being attached to a corresponding yielding rib 308 by any suitable technique known in the art, such as, for example and without limitation, by welding, adhesives, or the like.

The yielding feathers 310 are advantageously made of a material with a fusing temperature higher than the fusing temperature of the material of the seal liner of an associated spacer bar. Examples of suitable plastic materials are nylon, high temperature polypropylene, and the like, as known in the art. The seal liner of a spacer bar associated with the connector 300 is capable of being analogous to that of an associated spacer bar with respect to the connector 100 depicted in FIG. 1, and is typically an adhesive sealant that is capable of exhibiting elastic properties, as known in the art. As will be appreciated by those skilled in the art, with respect to embodiment shown in FIG. 3, the fusing temperature of the material of the yielding feathers 310 is capable being generally equal to the fusing temperature of the material of the yielding ribs 308. Alternatively, the fusing temperature of the material of the yielding feathers 310 is capable being generally higher or lower than the fusing temperature of the material of the yielding ribs 308. In the embodiment illustrated in FIG. 3, the connector body 302 further comprises a rigid stud 312 positioned generally adjacent a center line 314 of the connector body 302. As will be understood by a skilled artisan, the rigid stud 312 allows for required positioning of the connector body 302 with respect to an associated spacer bar.

The barrier members that in the embodiment of FIG. 3 comprise yielding ribs 308, covered at least partially with yielding feathers 310, engage with the seal liner of respective portions of an associated spacer bar in corresponding engaging areas, establishing thereby corresponding hermetic bonding resulting from a heating exposure of at least the corresponding engaging areas. In this embodiment, a heating temperature associated with the heating exposure, is lower than the fusing temperature of the material of the yielding ribs 308, and higher than the fusing temperature of the material of the seal liner of an associated spacer bar. Thus, the hermetic bonding is established by fusing the material of the seal liner of an associated spacer bar in the in corresponding engaging areas. A skilled artisan will understand that the fused material of the seal liner envelopes and adheres the yielding ribs 308 and the yielding feathers 310 in corresponding engaging areas. As will be appreciated by those skilled in the art, heating exposure of at least the corresponding engaging areas of respective portions of an associated spacer bar is provided by at least one of friction welding, ultrasonic welding, radio-frequency welding, microwaves welding, radiation heating, air heating, or direct heating.

Referring now to FIG. 4, there is shown a schematic view of a linear connector 400 for an associated spacer bar of an insulating glazing unit (not shown in the drawing), in accordance with another embodiment of the subject application. As shown in FIG. 4, the linear connector 400 comprises a connector body 402 including legs 404, 406. A skilled artisan will understand that the connector body 402 is capable of being made of a material analogous to the material of the connector body 102, depicted in FIG. 1. Each of the two legs 404, 406 of the connector body 402 is adapted for insertion into an inner space of a respective portion of an associated spacer bar and engaging with the respective portion of an associated spacer bar in corresponding engaging areas (not shown in the drawing).

The two legs of the connector body 402 are further adapted for forming multiple barriers for moisture vapor and gas, and comprise multiple barrier members. With respect to the embodiment of FIG. 4, the multiple barrier members include multiple yielding ribs 408 covering a first part of an exterior surface of a corresponding connector leg 404, 406 and fixedly attached to the corresponding connector leg 404, 406. In the embodiment of FIG. 4, the multiple barrier members further include multiple collars 410 covering a second part of an exterior surface of the corresponding connector leg, interlaced with the yielding ribs 408, and fixedly attached to the corresponding connector leg 406, 408. As will be recognized by those skilled in the art, the yielding ribs 408 and the collars 410 are capable of being attached to the corresponding connector leg 404, 406 by any suitable technique known in the art, such as, for example and without limitation, by welding, adhesives, or the like. In the embodiment illustrated in FIG. 4, the yielding ribs 408 are made of a material with a fusing temperature higher than a fusing temperature of a material of the seal liner of an associated spacer bar, wherein the collars 410 are made of a material with a fusing temperature lower than the fusing temperature of the material of the seal liner of an associated spacer bar.

Examples of suitable plastic materials for the yielding ribs 408 and the collars 410 are nylon, high temperature polypropylene, and the like, as known in the art. The seal liner of a spacer bar associated with the connector 400 is capable of being analogous to that of an associated spacer bar with respect to the connector 100 depicted in FIG. 1, and is typically an adhesive sealant that is capable of exhibiting elastic properties, as known in the art. In the embodiment illustrated in FIG. 4, the connector body 402 further comprises a rigid stud 412 positioned generally adjacent a center line 414 of the connector body 402. As will be understood by a skilled artisan, the rigid stud 412 allows for required positioning of the connector body 402 with respect to an associated spacer bar.

The barrier members that in the embodiment of FIG. 4 comprise yielding ribs 408, interlaced with collars 410, engage with the seal liner of respective portions of an associated spacer bar in corresponding engaging areas, establishing thereby corresponding hermetic bonding resulting from a heating exposure of at least the corresponding engaging areas. In this embodiment, a heating temperature associated with the heating exposure, is lower than the fusing temperature of the material of the seal liner of an associated spacer bar, and higher than the fusing temperature of the material of the collars 410. Thus, the hermetic bonding is established by fusing the material of the collars 410 in corresponding engaging areas. A skilled artisan will understand that the fused material of the collars 410 adheres the seal liner of an associated spacer bar in corresponding engaging areas. As will be further appreciated by those skilled in the art, heating exposure of at least the corresponding engaging areas of respective portions of an associated spacer bar is provided by at least one of friction welding, ultrasonic welding, radio-frequency welding, microwaves welding, radiation heating, air heating, or direct heating.

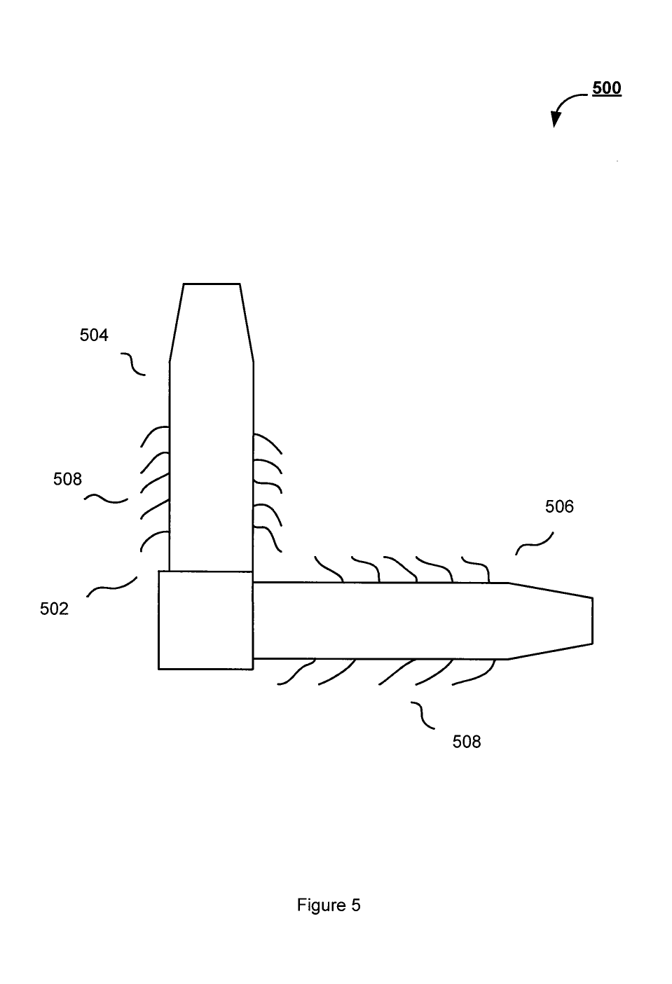

Turning now to FIG. 5, there is shown a schematic view of an example embodiment of a corner connector 500 for an associated spacer bar of an insulating glazing unit (not shown in the drawing), in accordance with one embodiment of the subject application. As shown in FIG. 5, the corner connector 500 comprises a connector body 502 including legs 504, 506. Those skilled in the art will appreciate that the material for the connector body 502 is capable of being analogous to that of the connector body 102 as depicted in FIG. 1. Each of the two legs 504, 506 of the connector body 402 is adapted for insertion into an inner space of a respective portion of an associated spacer bar and engaging with the respective portion of an associated spacer bar in corresponding engaging areas (not shown in the drawing). As shown in FIG. 5, the 504, 506 are positioned at right angles to each other.

As will be appreciated by those skilled in the art, in the embodiment of FIG. 5, the multiple barrier members include multiple yielding feathers 508 that are capable of being analogous to the yielding feathers 108. However, as will be further recognized by a skilled artisan, other barrier members, such as illustrated with respect to the embodiments of FIG. 2, FIG. 3, and FIG. 4, are equally capable of being implemented in a corner connector. Those skilled in the art will further recognize that the multiple barrier members of the subject application, including yielding feathers, yielding ribs, yielding feathered ribs, or interlaced yielding ribs and collars, ensure multiple barriers for moisture vapor and gas that secure a hermetically sealed joint in a spacer bar. The barrier members of the subject application, engage with the seal liner of respective portions of an associated spacer bar in corresponding engaging areas, wherein a predetermined relationship between the fusing temperature of the barrier members and the fusing temperature of the seal liner establishes hermetic bonding resulting from a heating exposure of the corresponding engaging areas. As will be understood by those skilled in the art, a spacer bar provided with one or more connectors in accordance with the subject application, may additionally be provided with an outer sealant overcoat, either one or multi layer to supply an additional vapor moisture barrier.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A connector for an associated spacer bar for an associated insulating glazing unit, which associated spacer bar includes an interior surface covered with a seal liner, and an inner space, the connector comprising:
a connector body comprising two legs;
wherein each of the two legs of the connector body is adapted for insertion into an inner space of a respective portion of an associated spacer bar and engaging with the respective portion of an associated spacer bar in corresponding engaging areas;
wherein the two legs of the connector body are further adapted for forming multiple barriers for moisture vapor and gas, and comprise multiple barrier members; and
wherein the multiple barrier members are adapted for engaging with the seal liner of respective portions of an associated spacer bar in corresponding engaging areas and establishing corresponding hermetic bonding in at least the corresponding engaging areas.

2. The connector for an associated spacer bar of an insulating glazing unit of claim 1 wherein the multiple barrier members are further adapted for establishing hermetic bonding resulting from a heating exposure of at least the corresponding engaging areas.

3. The connector for an associated spacer bar of an insulating glazing unit of claim 1 wherein the multiple barrier members are comprised of a plurality of yielding feathers covering at least a part of an exterior surface of a corresponding connector leg and fixedly attached to the corresponding connector leg.

4. The connector for an associated spacer bar of an insulating glazing unit of claim 3:
wherein the yielding feathers are made of a material with a fusing temperature higher than a fusing temperature of a material of the seal liner of an associated spacer bar; and
wherein a heating temperature associated with a heating exposure of at least the corresponding engaging areas, is lower than the fusing temperature of the material of the yielding feathers, and higher than the fusing temperature of the material of the seal liner of an associated spacer bar.

5. The connector for an associated spacer bar of an insulating glazing unit of claim 1 wherein the material of the yielding feathers is a plastic material.

6. The connector for an associated spacer bar of an insulating glazing unit of claim 1 wherein the multiple barrier members are comprised of a plurality of yielding ribs covering at least a part of an exterior surface of the corresponding connector leg and fixedly attached to the corresponding connector leg.

7. The connector for an associated spacer bar of an insulating glazing unit of claim 6:
wherein the yielding ribs are made of a material with a fusing temperature higher than a fusing temperature of a material of the seal liner of an associated spacer bar; and
wherein a heating temperature associated with a heating exposure of at least the corresponding engaging areas, is lower than the fusing temperature of the material of the yielding ribs, and higher than the fusing temperature of the material of the seal liner of an associated spacer bar.

8. The connector for an associated spacer bar of an insulating glazing unit of claim 6 wherein the yielding ribs are provided with a plurality of yielding feathers attached thereto and covering at least a part of an exterior surface of a corresponding yielding rib.

9. The connector for an associated spacer bar of an insulating glazing unit of claim 8:
wherein the yielding ribs and the yielding feathers are made of a material with a fusing temperature higher than a fusing temperature of a material of the seal liner of an associated spacer bar.

10. The connector for an associated spacer bar of an insulating glazing unit of claim 9:
wherein the fusing temperature of the material of the yielding feathers is generally equal to the fusing temperature of the material of the yielding ribs; and
wherein a heating temperature associated with the heating exposure, is lower than the fusing temperature of the material of the yielding feathers.

11. The connector for an associated spacer bar of an insulating glazing unit of claim 9:
wherein the fusing temperature of the material of the yielding feathers is higher than the fusing temperature of the material of the yielding ribs; and
wherein a heating temperature associated with the heating exposure, is lower than the fusing temperature of the material of the yielding ribs.

12. The connector for an associated spacer bar of an insulating glazing unit of claim 9:
wherein the fusing temperature of the material of the yielding feathers is lower than the fusing temperature of the material of the yielding ribs; and
wherein a heating temperature associated with the heating exposure, is lower than the fusing temperature of the material of the yielding feathers.

13. The connector for an associated spacer bar of an insulating glazing unit of claim 4 wherein the yielding ribs and yielding feathers are made of a plastic material.

14. The connector for an associated spacer bar of an insulating glazing unit of claim 1:
wherein the multiple barrier members comprise a plurality of yielding ribs covering a first part of an exterior surface of a corresponding connector leg and fixedly attached to the corresponding connector leg; and
wherein the multiple barrier members further comprise a plurality of collars covering a second part of an exterior surface of the corresponding connector leg, interlaced with the plurality of yielding ribs, and fixedly attached to the corresponding connector leg.

15. The connector for an associated spacer bar of an insulating glazing unit of claim 14:
wherein the yielding ribs are made of a material with a fusing temperature higher than a fusing temperature of a material of the seal liner of an associated spacer bar;
wherein the collars are made of a material with a fusing temperature lower than the fusing temperature of the material of the seal liner of an associated spacer bar; and
wherein a heating temperature associated with a heating exposure of at least the corresponding engaging areas, is lower than the fusing temperature of the material of the seal liner of an associated spacer bar, and higher than the fusing temperature of the material of the collars.

16. The connector for an associated spacer bar of an insulating glazing unit of claim 1:
wherein the two legs of the connector body are positioned such that an angle between the two legs of the connector body is more than zero and less than 180 degrees, the connector being a corner connector arrangement thereof.

17. The connector for an associated spacer bar of an insulating glazing unit of claim 1:
wherein the two legs of the connector body are positioned in-line, the connector being a linear connector arrangement thereof.

18. The connector for an associated spacer bar of an insulating glazing unit of claim 13 wherein the connector body further comprises a rigid stud positioned generally adjacent a center line of the connector body.

19. The connector for an associated spacer bar of an insulating glazing unit of claim 1 wherein heating exposure of the at least the corresponding engaging areas of respective portions of an associated spacer bar is provided by at least one of friction welding, ultrasonic welding, radio-frequency welding, microwaves welding, radiation heating, air heating, or direct heating.
